(19) United States
(12) Patent Application Publication
(10) Pub. No.: US 2013/0114474 A1
(43) Pub. Date: May 9, 2013

(54) SYSTEM AND METHOD FOR TRANSMITTING HARQ-ACK INFORMATION

(71) Applicant: Samsung Electronics Co., Ltd, Gyeonggi-do (KR)

(72) Inventors: Jingxing Fu, Beijing (CN); Chengjun Sun, Beijing (CN)

(73) Assignee: Samsung Electronics Co., Ltd, Gyeonggi-do (KR)

(21) Appl. No.: 13/671,319

(22) Filed: Nov. 7, 2012

(30) Foreign Application Priority Data
Nov. 7, 2011 (CN) 201110352600.0

(51) Int. Cl. H04W 72/04; H04J 3/00

(52) U.S. Cl. 370/280; 370/329

(57) ABSTRACT

According to one embodiment, a method for transmitting HARQ-ACK information, in which the HARQ-ACK information within a current bundling window is bundled, so that a total number of bits of the bundled HARQ-ACK information is compliant with a requirement associated with a length of the HARQ-ACK information required by a transmission format of the HARQ-ACK information, which may support carrier aggregation with more CCs in TDD UL/DL configuration 5, such that a peak throughput of user downlink is improved.

### CROSS-REFERENCE TO RELATED APPLICATION(S) AND CLAIM OF PRIORITY

The present application is related to and claims the benefit under 35 U.S.C. §119(a) of a Chinese Patent Application filed in the State Intellectual Property Office of the People's Republic of China on Nov. 7, 2011 and assigned Serial No. 201110352600.0, the entire disclosure of which is hereby incorporated by reference.

### TECHNICAL FIELD OF THE INVENTION

The present invention relates to radio communications system technologies, and particularly to a method for transmitting HARQ-ACK information.

### BACKGROUND OF THE INVENTION

Long term evolution (LTE) system typically conveys data transmission based on hybrid automatic repeat request (HARQ), such as, according to receiving scenario for data. A data receiver may correspondingly send the HARQ-ACK information of Acknowledgement (ACK) or Negative Acknowledgement (NACK). Scheduling information of dynamic downlink data transmission is transmitted via a physical downlink control channel (PDCCH).

For LTE Time Division Duplex (TDD) system, when the number of downlink sub-frames is greater than the number of uplink sub-frames, the HARQ-ACK information of multiple downlink sub-frames often needs to be centralized in the same uplink sub-frame and transmitted. One kind of information method is to perform an AND operation on HARQ-ACK information for downlink sub-frames of each transmission data to respectively obtain 1-bit HARQ-ACK information for each codeword. Because downlink data transmission is dynamically scheduled via a PDCCH, and a user terminal (UE) may not correctly receive the PDCCH sent by a base station, the above-mentioned method of performing this AND operation in accordance with the codeword may result in ambiguity both to the transmitter and receiver.

To solve the above-mentioned problem, in LTE TDD, a downlink assignment indicator (DAI) is used to identify a series number of the current downlink sub-frame that have sent the PDCCH in a radio frame, so that the UE can detect whether a PDCCH within the downlink sub-frame is lost or not. For a radio frame in which the number of the downlink sub-frames is 4, a value of DAI may be 1, 2, 3 and 4.

However, a problem exists in the above method in which the UE is unable to detect the loss of the last several PDCCHs, thus in the LTE TDD, it is required that a UE gives HARQ-ACK information via a HARQ-ACK information channel corresponding to the last downlink sub-frame in which the UE receives the PDCCH. Therefore, according to the channel by which the UE gives the HARQ-ACK information, a base station can recognize whether the UE loses PDCCHs of the last several downlink sub-frames or not.

In LTE-Advanced (LTE-A) systems, carrier aggregation (CA) technology is used to support a higher transmission rate, such as, two or more component carriers (CC) that are aggregately transmitted to obtain greater bandwidth. For example, in order to support 100 MHz bandwidth, the bandwidth may be achieved by aggregating five 20 MHz CCs. Based on CA, a base station sends downlink data to the same UE in two or more CCs, accordingly, the UE also needs to support information about receiving scenarios of downlink data received from two or more CCs.

According to current description of LTE-A protocol, PUCCH format 3 can support HARQ-ACK information of not more than 20 bits. That is, for TDD uplink/downlink configuration (TDD UL/DL configuration) 0, 1, 2, 3, 4 and 6, the PUCCH format 3 can support carrier aggregation with five CCs. However, for TDD UL/DL configuration 5, the PUCCH format 3 supports carrier aggregation up to two CCs. Because for TDD UL/DL configuration 5, each CC's HARQ-ACK information in an uplink sub-frame has 9 bits even after being bundled by spatial bundling, and five CCs are added up to 45 bits, which are greater than the maximum allowable 20 bits supported by PUCCH format 3. Therefore, it is required to bundle 45 bits into 20 bits. The PUCCH format 1b with channel selection only applies to the TDD UL/DL configuration 0, 1, 2, 3, 4 and 6. In TDD UL/DL configuration 5, the PUCCH format 1b with channel selection is not supported by the prior art, and needs to design a bundling solution to support PUCCH format 1b with channel selection in TDD UL/DL configuration 5.

### SUMMARY OF THE INVENTION

To address the above-discussed deficiencies of the prior art, it is a primary object to provide a system and method for transmitting HARQ-ACK information to support carrier aggregation with more CCs in TDD UL/DL configuration 5, such that the peak throughput of user downlink may be improved.

The method for transmitting HARQ-ACK information provided by embodiments of the present invention, which is applied such that each component carrier (CC) of carrier aggregation adopts time division duplex uplink/downlink configuration (TDD UL/DL configuration) 5 including: receiving, by a user equipment (UE), physical downlink shared channel (PDSCH) data from each CC, and obtaining corresponding HARQ-ACK information; obtaining, by the UE, a size of a bundling window within a current HARQ-ACK feedback cycle; the UE bundling the HARQ-ACK information within the current bundling window according to the number of configured CCs, the size of the bundling window and a transmission format of the HARQ-ACK information, so that a total number of bits of the bundled HARQ-ACK information of all CCs is compliant with a requirement about length of the HARQ-ACK information required by the transmission format of the HARQ-ACK information; transmitting, by the UE, the bundled HARQ-ACK information to a base station via a uplink physical channel.

Preferably, the requirement about the length of the HARQ-ACK information required by the transmission format of the HARQ-ACK information includes the length is less than or equal to Nb bits; and

the UE bundling the HARQ-ACK information within the current bundling window includes when a total number of bits of the HARQ-ACK information of all the CCs is greater than Nb, then the UE performs spatial bundling on the HARQ-ACK information of all the CCs; when the total number of bits of the HARQ-ACK information of all the CCs after being bundled by the spatial bundling is greater than Nb, then the UE performs time domain bundling on the HARQ-ACK information of all the CCs.

Preferably, the requirement associated with the length of the HARQ-ACK information required by the transmission format of the HARQ-ACK information includes the length is less than or equal to Nb bits; and the UE bundling the HARQ-ACK information within the current bundling window includes: when a total number of bits of the HARQ-ACK information of all the CCs is greater than Nb, then the UE performs spatial bundling on the HARQ-ACK information of each CC one by one from one of the CCs, until the total number of bits of the HARQ-ACK information of all the CCs is less than or equal to Nb or the spatial bundling is performed on the HARQ-ACK information of all CCs; when the total number of bits of the HARQ-ACK information of all the CCs after being bundled by the spatial bundling is greater than Nb, then the UE performs time domain bundling on the HARQ-ACK information of each CC one by one from one of the CCs, until the total number of bits of the HARQ-ACK information of all the CCs is less than or equal to Nb.

Preferably, the UE performing the time domain bundling includes the HARQ-ACK information of each downlink sub-frame within the bundling window of the CC is reordered according to an ascending order of downlink assignment indicators (DAI) of downlink sub-frames within the bundling window of the CC, the HARQ-ACK information of a downlink sub-frame in which a PDCCH is not received is set as DTX and ordered in the back, and reordered HARQ-ACK information is obtained; Table 1 is checked by using the reordered HARQ-ACK information, so that a corresponding HARQ-ACK indicator is obtained; the HARQ-ACK indicator is the HARQ-ACK information of the CC after being bundled by the time domain bundling:

TABLE 1

| Serial | | | | | | | | | | HARQ-ACK |
|---|---|---|---|---|---|---|---|---|---|---|
| number | HARQ-ACK information | | | | | | | | | indicator |
| 0 | ACK | ACK | ACK | ACK | ACK | ACK | ACK | ACK | ACK | 0000 |
| 1 | ACK | ACK | ACK | ACK | ACK | ACK | ACK | ACK | N/D | 0001 |
| 2 | ACK | ACK | ACK | ACK | ACK | ACK | ACK | N/D | any | 0010 |
| 3 | ACK | ACK | ACK | ACK | ACK | ACK | N/D | any | any | 0011 |
| 4 | ACK | ACK | ACK | ACK | ACK | N/D | any | any | any | 0100 |
| 5 | ACK | ACK | ACK | ACK | N/D | any | any | any | any | 0101 |
| 6 | ACK | ACK | ACK | N/D | any | any | any | any | any | 0110 |
| 7 | ACK | ACK | N/D | any | any | any | any | any | any | 0111 |
| 8 | ACK | N/D | any | any | any | any | any | any | any | 1000 |
| 9 | N/D | any | any | any | any | any | any | any | any | 1001 |

Preferably, the UE performing the time domain bundling includes the number of downlink sub-frames actually scheduled by the base station within the current bundling window is determined according to uplink downlink assignment indicator (UL DAL) in uplink grant (UL grant) of a PDCCH scheduling a physical uplink shared channel (PUSCH) and the number of downlink sub-frames in which the UE receives PDCCHs; the HARQ-ACK information of downlink sub-frames scheduled actually within the bundling window of the CC is reordered according to an ascending order of DAIs of downlink sub-frames within the bundling window of the CC, the HARQ-ACK information of a downlink sub-frame in which a PDCCH is not received is set as DTX and ordered in the back, and reordered HARQ-ACK information whose length is the number of the downlink sub-frames scheduled actually is obtained; when the length of the reordered HARQ-ACK information is greater than 7, then Table 2 is checked by using the reordered HARQ-ACK information, so that a corresponding HARQ-ACK indicator is obtained; when the length of the reordered HARQ-ACK information is less than or equal to 7, then Table 3 is checked by using the reordered HARQ-ACK information, so that the corresponding HARQ-ACK indicator is obtained; the HARQ-ACK indicator is the HARQ-ACK information of the CC after being bundled by the time domain bundling:

TABLE 2

| Serial | | | | | | | | | | HARQ-ACK |
|---|---|---|---|---|---|---|---|---|---|---|
| number | HARQ-ACK information | | | | | | | | | indicator |
| 0 | ACK | ACK | ACK | ACK | ACK | ACK | ACK | ACK | ACK | 0000 |
| 1 | ACK | ACK | ACK | ACK | ACK | ACK | ACK | ACK | N/D | 0001 |
| 2 | ACK | ACK | ACK | ACK | ACK | ACK | ACK | N/D | any | 0010 |
| 3 | ACK | ACK | ACK | ACK | ACK | ACK | N/D | any | any | 0011 |
| 4 | ACK | ACK | ACK | ACK | ACK | N/D | any | any | any | 0100 |
| 5 | ACK | ACK | ACK | ACK | N/D | any | any | any | any | 0101 |
| 6 | ACK | ACK | ACK | N/D | any | any | any | any | any | 0110 |
| 7 | ACK | ACK | N/D | any | any | any | any | any | any | 0111 |
| 8 | ACK | N/D | any | any | any | any | any | any | any | 1000 |
| 9 | N/D | any | any | any | any | any | any | any | any | 1001 |

TABLE 3

| Serial | | | | | | | | HARQ-ACK |
|---|---|---|---|---|---|---|---|---|
| number | HARQ-ACK information | | | | | | | indicator |
| 0 | ACK | ACK | ACK | ACK | ACK | ACK | ACK | 000 |
| 1 | ACK | ACK | ACK | ACK | ACK | ACK | N/D | 001 |
| 2 | ACK | ACK | ACK | ACK | ACK | N/D | any | 010 |
| 3 | ACK | ACK | ACK | ACK | N/D | any | any | 011 |
| 4 | ACK | ACK | ACK | N/D | any | any | any | 100 |
| 5 | ACK | ACK | N/D | any | any | any | any | 101 |
| 6 | ACK | N/D | any | any | any | any | any | 110 |
| 7 | N/D | any | any | any | any | any | any | 111 |

Preferably, the UE performing the time domain bundling includes the HARQ-ACK information of each downlink sub-frame within the bundling window of the CC is reordered according to an ascending order of DAIs of downlink sub-frames within the bundling window of the CC, the HARQ-ACK information of a downlink sub-frame in which a PDCCH is not received is set as DTX and ordered in the back, and reordered HARQ-ACK information is obtained; when the number of consecutive ACKs from the first bit in the reordered HARQ-ACK information is 3, 6 or 9, and values of remaining bits are all DTX, then the reordered HARQ-ACK information is mapped as A, A, and a corresponding HARQ-ACK indicator is 11; when the number of the consecutive ACKs from the first bit in the reordered HARQ-ACK information is 2 or 5, and the values of the remaining bits are all DTX, or, the number of the consecutive ACKs from the first bit is 8 and the value of the ninth bit is NACK/DTX, then the reordered HARQ-ACK information is mapped as N/D, A, and the corresponding HARQ-ACK indicator is 10; when the number of the consecutive ACKs from the first bit in the reordered HARQ-ACK information is 1 or 4, and the values of the remaining bits are all DTX, or, the number of the consecutive ACKs from the first bit is 7, the value of the eighth bit is NACK/DTX, and the value of the ninth bit is any of ACK, NACK and DTX, then the reordered HARQ-ACK information is mapped as A, N/D, and the corresponding HARQ-ACK indicator is 01; when the value of the first bit in the reordered HARQ-ACK information is DTX, and the values of the remaining eight bits are any of ACK, NACK and DTX, then the HARQ-ACK information is not transmitted; and otherwise, the reordered HARQ-ACK information is mapped as N/D, N/D, and the corresponding HARQ-ACK indicator is 00, wherein the HARQ-ACK indicator is the HARQ-ACK information of the CC after being bundled by the time domain bundling.

In some embodiments, the size of the bundling window in the current HARQ-ACK feedback cycle is obtained by reading system configuration information.

The UE transmits the bundled HARQ-ACK information of all the CC to the base station via a PUCCH.

In some embodiments, the size of the bundling window in the current HARQ-ACK feedback cycle is obtained by reading a UL DAL in UL grant of a PDCCH scheduling PUSCH, and according to the number of downlink sub-frames in which the PDCCH is received by the UE. The UE transmits the bundled HARQ-ACK information of all the CC to the base station via a PUSCH.

In some embodiments, the transmission format of the HARQ-ACK information is PUCCH format 3 or PUCCH format 1b.

In view of the above-mentioned technical solution, in certain embodiments, by bundling the HARQ-ACK information within a current bundling window, a total number of bits of the bundled HARQ-ACK information is compliant with a requirement associated with the length of the HARQ-ACK information required by a transmission format of the HARQ-ACK information, which may support carrier aggregation with more CCs in TDD UL/DL configuration 5, such that the peak throughput of a user downlink may be improved.

In addition, in a preferable method, provided by the present invention, for bundling HARQ-ACK information based on performing HARQ-ACK information according to the number of downlink sub-frames scheduled actually within a current bundling window. When the number of downlink sub-frames scheduled actually is less than or equal to 7, the HARQ-ACK information of each CC is bundled into 3 bits by using this bundling method. On the one hand, it saves HARQ-ACK information resources, thus improving transmission efficiency of the HARQ-ACK information. On the other hand, as compression efficiency is higher, the number of the CCs to be bundled is minimized, while a total number of bits of the HARQ-ACK information meets the requirements, thereby the downlink throughput performance of the system is improved.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example method for transmitting HARQ-ACK information according to embodiments of the present invention.

### DETAILED DESCRIPTION OF THE INVENTION

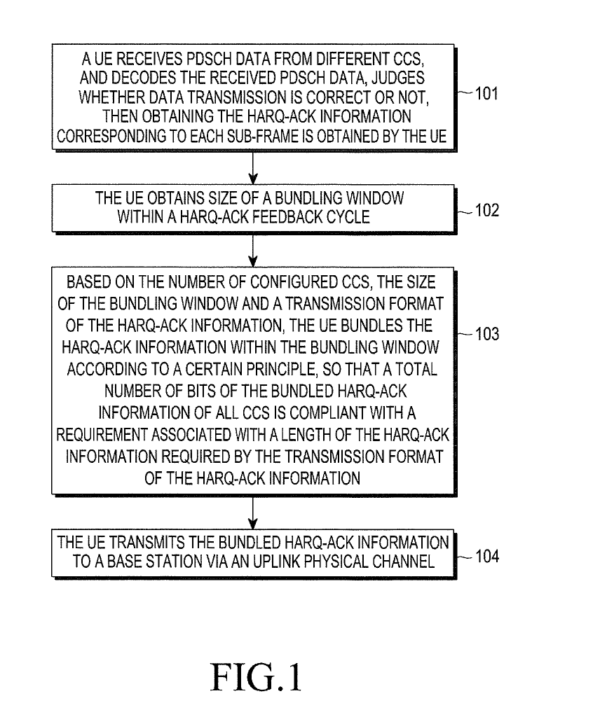

FIG. 1, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communication network system. To make the objective, technical solutions and advantages of the present invention more clearly, the present invention is explained in detail as follows with reference to drawings and embodiments.

FIG. 1 illustrates an example method for transmitting HARQ-ACK information according to embodiments of the present invention. The method includes following steps.

Step 101: a UE receives physical downlink shared channel (PDSCH) data from different component carriers (CCs), and decodes the received PDSCH data, judges whether data transmission is correct or not, then obtaining the HARQ-ACK information corresponding to each sub-frame by the UE.

Step 102: the UE obtains size of a bundling window within a HARQ-ACK feedback cycle.

The first embodiment for obtaining the size of bundling window within the current HARQ-ACK feedback cycle includes the size obtained by reading system configuration information. For example, the system configuration information indicates that the current TDD UL/DL configuration is 5, and then the UE recognizes that the size of the bundling window within the current HARQ-ACK feedback cycle is 9.

The second embodiment for obtaining the size of bundling window within the current HARQ-ACK feedback cycle includes, by reading a UL DAL in uplink grant (UL grant) of a PDCCH of a physical uplink shared channel (PUSCH), the size is determined according to a value of the UL DAI and the number of downlink sub-frames in which the UE receives PDCCHs.

The length of UL DAI in the UL grant is 2 bits, the number of downlink sub-frames scheduled actually is subtracted 1 by the base station and then modulo 4, the modulo result is set as the value of UL DAI.

For example, when the value of UL DAI is 0, the number of downlink sub-frames scheduled actually may be 1, 5 or 9; when the value of UL DAI is 3, the number of downlink sub-frames scheduled may be 0, 4 or 8. The UE may determine the size of bundling window within the current HARQ-ACK feedback cycle according to the value of UL DAI and the number of downlink sub-frames in which a PDCCH is received. For example, it is assumed that the value of UL DAI is 3 and a terminal receives six downlink sub-frames of PDCCH, then the size of bundling window is UL DAI-4+1=8.

Step 103: based on the number of configured CCs, the size of the bundling window and a transmission format of the HARQ-ACK information, the UE bundles the HARQ-ACK information within the bundling window according to a certain bundling window, so that a total number of bits of the bundled HARQ-ACK information of all CCs is compliant with a requirement associated with a length of the HARQ-ACK information required by the transmission format of the HARQ-ACK information.

In the first embodiment, the bundling window includes if the total number of bits of the HARQ-ACK information of all CCs in CA is less than or equal to Nb bits (e.g., 20 bits stated by PUCCH format 3), then time domain bundling and spatial bundling are not performed. For example, it is assumed that the number of configured CCs is 1, the size of bundling window is 9, and Nb=20, when Single-Input Multiple-Output (SIMO) is performed within this bundling window, the 9-bit HARQ-ACK information is generated, as 9 is less than Nb (i.e., 20), it does not need to perform the time domain bundling and spatial bundling; when Multiple-Input Multiple-Output (MIMO) is performed within this bundling window, the 18-bit HARQ-ACK information is generated, as 18 is less than Nb (i.e., 20), it does not need to perform the time domain bundling and spatial bundling either. If the total number of bits of the HARQ-ACK information of all CCs in CA is greater than Nb bits, then the spatial bundling is performed on HARQ-ACK information. If the total number of bits of the HARQ-ACK information after being bundled by the spatial bundling is less than or equal to Nb bits, then the time domain bundling is not performed. For example, if the number of CCs is 2, the size of the bundling window is 9, and Nb=20, when MIMO is performed within this bundling window, the 36-bit HARQ-ACK information is generated. As 36 is greater than Nb (i.e., 20), the spatial bundling is performed to generate 18-bit HARQ-ACK information, while 18 is less than Nb bits, does not need to perform the time domain bundling. If the total number of bits of the HARQ-ACK information, after being bundled by the spatial bundling, of all CCs in CA is still greater than Nb bits, then the time domain bundling is performed to generate HARQ-ACK information whose length is less than or equal to Nb bits. For example, if the number of CCs is 3, the size of the bundling window is 9, and Nb=20, when MIMO is performed within this bundling window, the 54-bit HARQ-ACK information is generated, and 27-bit HARQ-ACK information is generated by performing the spatial bundling. As 27 is still greater than 20 bits, the HARQ-ACK information of each CC is bundled into 4 bits by performing the time domain bundling, thus 12-bit HARQ-ACK information is generated.

In the second embodiment, the bundling window includes: if the total number of bits of the HARQ-ACK information of all CCs in CA is less than or equal to Nb bits, then time domain bundling and spatial bundling are not performed. If the total number of bits of the HARQ-ACK information of all CCs in CA is greater than Nb bits, then the spatial bundling is performed on each CC one by one from one of the CCs, until the total number of bits of the HARQ-ACK information of all CCs is less than or equal to Nb bits. The spatial bundling is not performed on the next CC anymore. For example, it is assumed that Nb=20, if the number of CCs is 3, HARQ-ACK information is transmitted in a PUSCH channel, and the size of the bundling window is determined as 4 according to UL DAI and detecting a PDCCH, when MIMO is performed within this bundling window, the 24-bit HARQ-ACK information is generated, as 24 is greater than 20 bits, the spatial bundling is need to be performed. First, the spatial bundling is performed on 8-bit HARQ-ACK information of a CC to obtain 4-bit HARQ-ACK information. At this time, the total number of bits of the HARQ-ACK information of all CCs is 20 bits, does not need to perform the spatial bundling on remaining two CCs. If the total number of bits of the HARQ-ACK information of all CCs in CA is greater than Nb, and the spatial bundling is performed on all the CCs, and, if the total number of bits of the HARQ-ACK information of all CCs is still greater than Nb bits, then the time domain bundling is performed on each CC one by one from one of the CCs, until the total number of bits of the HARQ-ACK information is less than or equal to Nb bits. The time domain bundling is not performed on the next CC anymore. For example, assuming that Nb=20, if the number of CCs is 3, HARQ-ACK information is transmitted in a PUSCH channel, and the size of the bundling window is determined as 7 according to UL DAI and detecting a PDCCH, when MIMO is performed within this bundling window, the 42-bit HARQ-ACK information is generated. As 42 is greater than Nb bits, the spatial bundling is performed on HARQ-ACK information of three CCs to generate 21-bit HARQ-ACK information. Then, the time domain bundling is performed on 7-bit HARQ-ACK information of a CC first, and the number of bits of HARQ-ACK information of this CC becomes 4, the sum of 4 and the number of bits of HARQ-ACK information of other two CCs that do not be bundled by the time domain bundling is 18, which is less than Nb. Then it does not need to perform the time domain bundling on remaining two CCs.

Another embodiment for time domain bundling provided by the present invention includes for TDD UL/DL configuration 5, an uplink sub-frame gives HARQ-ACK information of up to nine downlink sub-frames, that is, the size of the bundling window is 9. The HARQ-ACK information of each downlink sub-frame within the bundling window of the CC is reordered according to an ascending order of DAIs of nine downlink sub-frames within the bundling window of the CC, the HARQ-ACK information of a downlink sub-frame in which a PDCCH is not received is set as DTX and ordered in the back, and reordered HARQ-ACK information is obtained. Table 1 is checked by using the reordered HARQ-ACK information, so that a corresponding HARQ-ACK indicator is obtained. The HARQ-ACK indicator is the HARQ-ACK information of the CC after being bundled by the time domain bundling.

For example, assuming that a value of DAI of sub-frame 0 of a CC is 1, the HARQ-ACK information of sub-frame 0 is ACK; the value of DAI of sub-frame 2 is 2, the HARQ-ACK information of sub-frame 2 is ACK; the value of DAI of sub-frame 5 is 3, the HARQ-ACK information of sub-frame 5 is ACK; the value of DAI of sub-frame 8 is 4, the HARQ-ACK information of sub-frame 8 is NACK; the remaining sub-frames do not receive the PDCCH, then, the reordered HARQ-ACK information of this CC is as follows:

| | |
|---|---|
| DAI: | 1 2 3 4 |
| HARQ-ACK: | ACK, ACK, ACK, N/D, N/D, N/D, N/D, N/D, N/D |

Table 1 is checked by using HARQ-ACK information of ACK, ACK, ACK, N/D, N/D, N/D, N/D, N/D, N/D and the corresponding HARQ-ACK indicator is 0110, then the bundled HARQ-ACK information of this CC is 0110.

The HARQ-ACK indicator corresponding to CCs is recorded as HARQ-ACKn, in which n represents serial number of the CC, the range of n is 0 to N−1, in which N is the number of CCs configured for the UE. For the UE configured with multiple CCs, the HARQ-ACK information is as follows:

HARQ-ACK₀, HARQ-ACK₁, . . . , HARQ-ACK_{N-1}

TABLE 1

| Serial | | | | | | | | | | HARQ-ACK |
|---|---|---|---|---|---|---|---|---|---|---|
| number | HARQ-ACK information | | | | | | | | | indicator |
| 0 | ACK | ACK | ACK | ACK | ACK | ACK | ACK | ACK | ACK | 0000 |
| 1 | ACK | ACK | ACK | ACK | ACK | ACK | ACK | ACK | N/D | 0001 |
| 2 | ACK | ACK | ACK | ACK | ACK | ACK | ACK | N/D | any | 0010 |
| 3 | ACK | ACK | ACK | ACK | ACK | ACK | N/D | any | any | 0011 |
| 4 | ACK | ACK | ACK | ACK | ACK | N/D | any | any | any | 0100 |
| 5 | ACK | ACK | ACK | ACK | N/D | any | any | any | any | 0101 |
| 6 | ACK | ACK | ACK | N/D | any | any | any | any | any | 0110 |
| 7 | ACK | ACK | N/D | any | any | any | any | any | any | 0111 |
| 8 | ACK | N/D | any | any | any | any | any | any | any | 1000 |
| 9 | N/D | any | any | any | any | any | any | any | any | 1001 |

Another embodiment for time domain bundling includes for TDD UL/DL configuration 5, an uplink sub-frame gives HARQ-ACK information of up to nine downlink sub-frames, that is, the size of the bundling window is 9. However, when HARQ-ACK information is transmitted in the PUSCH, the number of downlink sub-frames actually scheduled by the base station within the current bundling window may be determined according to schedule a UL DAL in UL grant of a PUSCH and the number of downlink sub-frames in which the UE receives PDCCHs. The HARQ-ACK information of downlink sub-frames scheduled within the bundling window of the CC is reordered according to an ascending order of DAIs, the HARQ-ACK information of a downlink sub-frame in which a PDCCH is not received is set as DTX and ordered to the back, and reordered HARQ-ACK information is obtained, whose length is the number of the downlink sub-frames scheduled actually of this CC, which is the actual size of the bundling window.

If the length of the reordered HARQ-ACK information is 8 or 9, then Table 1 is checked by using this reordered HARQ-ACK information, so that a corresponding HARQ-ACK indicator is obtained. If the length of the reordered HARQ-ACK information is less than or equal to 7, then Table 2 is checked by using this reordered HARQ-ACK information, so that the corresponding HARQ-ACK indicator is obtained. The HARQ-ACK indicator is the HARQ-ACK information of the CC after being bundled by the time domain bundling.

For example, it is assumed that the actual size of the bundling window is 7, a value of DAI of sub-frame 0 of a CC is 1, the HARQ-ACK information of sub-frame 0 is ACK, the value of DAI of sub-frame 3 is 2, the HARQ-ACK information of sub-frame 3 is ACK. the value of DAI of sub-frame 6 is 3, the HARQ-ACK information of sub-frame 6 is NACK. and the remaining sub-frames do not receive the PDCCH; then, the reordered HARQ-ACK information of this CC is as follows:

| | |
|---|---|
| DAI: | 1 2 3 |
| HARQ-ACK: | ACK, ACK, NACK, N/D, N/D, N/D, N/D |

Table 2 is checked by using HARQ-ACK information of ACK, ACK, N/D, N/D, N/D, N/D, N/D and the corresponding HARQ-ACK indicator is 101, then the bundled HARQ-ACK information of this CC is 101.

The HARQ-ACK indicator corresponding to CCn is recorded as HARQ-ACKn, in which n represents serial number of the CC, the range of n is 0 to N−1, in which N is the number of CCs configured for the UE. For the UE configured with multiple CCs, the HARQ-ACK information is as follows:

HARQ-ACK₀, HARQ-ACK₁, . . . , HARQ-ACK_{N-1}

TABLE 2

| Serial | | | | | | | | HARQ-ACK |
|---|---|---|---|---|---|---|---|---|
| number | HARQ-ACK information | | | | | | | indicator |
| 0 | ACK | ACK | ACK | ACK | ACK | ACK | ACK | 000 |
| 1 | ACK | ACK | ACK | ACK | ACK | ACK | N/D | 001 |
| 2 | ACK | ACK | ACK | ACK | ACK | N/D | any | 010 |
| 3 | ACK | ACK | ACK | ACK | N/D | any | any | 011 |
| 4 | ACK | ACK | ACK | N/D | any | any | any | 100 |
| 5 | ACK | ACK | N/D | any | any | any | any | 101 |
| 6 | ACK | N/D | any | any | any | any | any | 110 |
| 7 | N/D | any | any | any | any | any | any | 111 |

In above-mentioned embodiment, for time domain bundling, the HARQ-ACK information is achieved according to the number of downlink sub-frames scheduled within a current bundling window. When the number of downlink sub-frames scheduled is less than or equal to 7, the HARQ-ACK information of each CC is bundled into 3 bits. On the one hand, it saves 1-bit HARQ-ACK information resources compared with an above-mentioned embodiment for time domain bundling provided by the present invention, thus improving transmission efficiency of the HARQ-ACK information. On the other hand, as compression efficiency is higher, the number of the CCs to be bundled is minimized, while a total number of bits of the HARQ-ACK information meets the requirements, thereby the downlink throughput performance of the system is improved according to certain embodiments.

Embodiments of the present invention further provide an embodiment for time domain bundling. In this method, first, the HARQ-ACK information of the CC is reordered according to the same manner as the previous two embodiments for time domain bundling, then Table 3 is checked by using this reordered HARQ-ACK information, so that the corresponding HARQ-ACK indicator is obtained. The HARQ-ACK indicator is the HARQ-ACK information of the CC after being bundled by the time domain bundling.

The Table 3 is explained as follows.

If the number of consecutive ACKs from the first bit in the HARQ-ACK information is 3, 6 or 9, and values of remaining bits are all DTX, then this HARQ-ACK information is mapped as 2 bits (A, A), and a corresponding HARQ-ACK indicator is 11, as shown in Table 3, line 2. In other words, the HARQ-ACK information meeting the following conditions is mapped as A, A. The values of previous three bits of the HARQ-ACK information are all ACK, the values of other six bits are all DTX, i.e., “A, A, A, D, D, D, D, D, D”. The values of previous six bits of the HARQ-ACK information are all ACK, the values of other three bits are all DTX, i.e., “A, A, A, A, A, A, D, D, D”. Also the values of all bits of the HARQ-ACK information are ACK, i.e., “A, A, A, A, A, A, A, A, A”.

If the number of the consecutive ACKs from the first bit in the HARQ-ACK information is 2 or 5, and the values of the remaining bits are all DTX, or, the number of the consecutive ACKs from the first bit is 8 and the value of the ninth bit is NACK/DTX, then this HARQ-ACK information is mapped as 2 bits (N/D, A), and the corresponding HARQ-ACK indicator is 10, as shown in Table 3, line 3. In other words, the HARQ-ACK information meeting the following conditions is mapped as N/D, A. The values of previous two bits of the HARQ-ACK information are all ACK, the values of other seven bits are all DTX, i.e., “A, A, D, D, D, D, D, D, D”. The values of previous five bits of the HARQ-ACK information are all ACK, the values of other four bits are all DTX, i.e., “A, A, A, A, A, D, D, D, D”. Additionally, the values of previous eight bits of the HARQ-ACK information are all ACK, the value of the ninth bit is DTX, i.e., “A, A, A, A, A, A, A, A, D/N”.

If the number of the consecutive ACKs from the first bit in the HARQ-ACK information is 1 or 4, and the values of the remaining bits are all DTX, or, the number of the consecutive ACK from the first bit is 7, the value of the eighth bit is NACK/DTX, and the value of the ninth bit is any of ACK, NACK and DTX, then this HARQ-ACK information is mapped as 2 bits (A, N/D), and the corresponding HARQ-ACK indicator is 01, as shown in Table 3, line 4. In other words, the HARQ-ACK information meeting the following conditions is mapped as A, N/D. The value of the first bit of the HARQ-ACK information is ACK, the values of other eight bits are all DTX, i.e., “A, D, D, D, D, D, D, D, D”. The values of previous four bits of the HARQ-ACK information are all ACK, the values of other five bits are all DTX, i.e., “A, A, A, A, D, D, D, D, D”. Also the values of previous seven bits of the HARQ-ACK information are all ACK, the value of the eighth bit is NACK/DTX, and the value of the ninth bit is any of ACK, NACK and DTX, i.e., “A, A, A, A, A, A, A, D/N, any”.

If the value of the first bit in the HARQ-ACK information is DTX, and the values of other eight bits are any of ACK, NACK and DTX, i.e., “D, any value, any value, any value, any value, any value, any value, any value, any value”, then this HARQ-ACK information is mapped as (D, N/D) and does not need to be transmitted, as shown in Table 3, line 6.

For other cases in addition to the above-mentioned cases, the HARQ-ACK information is mapped as 2 bits (N/D, N/D), and the corresponding HARQ-ACK indicator is 00, as shown in Table 3, line 5. Specifically, (N/D, N/D) may indicate the HARQ-ACK information as follows.

The value of the first bit is NACK, the values of other eight bits may be any of ACK, NACK and DTX; or, the (N/D, N/D) indicates information cases in which the number of consecutive ACKs is 1 other than “A, D, D, D, D, D, D, D, D”; or, the (N/D, N/D) indicates information cases in which the number of consecutive ACKs is 2 other than “A, A, D, D, D, D, D, D, D”; or, the (N/D, N/D) indicates information cases in which the number of consecutive ACKs is 3 other than “A, A, A, D, D, D, D, D, D”; or, the (N/D, N/D) indicates information cases in which the number of consecutive ACKs is 4 other than “A, A, A, A, D, D, D, D, D”; or, the (N/D, N/D) indicates information cases in which the number of consecutive ACKs is 5 other than “A, A, A, A, A, D, D, D, D”; or, the (N/D, N/D) indicates information cases in which the number of consecutive ACKs is 6 other than “A, A, A, A, A, A, D, D, D”.

TABLE 3

| up to nine HARQ-ACK information within a | Mapping | HARQ-ACK |
|---|---|---|
| bundling window | state | indicator |
| A, A, A, A, A, A, A, A, A | A, A | 11 |
| or, A, A, A, A, A, A, D, D, D | | |
| or, A, A, A, D, D, D, D, D, D | | |
| A, A, A, A, A, A, A, A, D/N | N/D, A | 10 |
| or, A, A, A, A, A, D, D, D, D | | |
| or, A, A, D, D, D, D, D, D, D | | |
| A, A, A, A, A, A, A, D/N, any | A, N/D | 01 |
| or, A, A, A, A, D, D, D, D, D | | |
| or, A, D, D, D, D, D, D, D, D | | |
| N, any, any, any, any, any, any, any, any | N, N/D | 00 |
| or, A, D/N, any, any, any, any, any, any, any | | |
| except A, D, D, D, D, D, D, D, D | | |
| or, A, A, D/N, any, any, any, any, any, any | | |
| except A, A, D, D, D, D, D, D, D | | |
| or, A, A, A, D/N, any, any, any, any, any | | |
| except A, A, A, D, D, D, D, D, D | | |
| or, A, A, A, A, D/N, any, any, any, any | | |
| except A, A, A, A, D, D, D, D, D | | |
| or, A, A, A, A, A, D/N, any, any, any | | |
| except A, A, A, A, A, D, D, D, D | | |
| or, A, A, A, A, A, A, D/N, any, any | | |
| except A, A, A, A, A, A, D, D, D | | |
| D, any, any, any, any, any, any, any, any | D, N/D | No transmitting |

Step 104: the UE transmits the bundled HARQ-ACK information to a base station via an uplink physical channel.

If in step 102, the first embodiment for obtaining the size of the bundling window within the current HARQ-ACK feedback cycle is adopted, then, in step 104, the HARQ-ACK information is transmitted to the base station via a PUCCH.

If in step 102, the second embodiment for obtaining the size of the bundling window within the current HARQ-ACK feedback cycle is adopted, then, in step 104, the HARQ-ACK information is transmitted to the base station via a PUSCH.

In view of the above-mentioned embodiments, the present invention provides one or more methods for transmitting HARQ-ACK information, in which the HARQ-ACK information within a current bundling window is bundled, so that a total number of bits of the bundled HARQ-ACK information is compliant with a requirement associated with the length of the HARQ-ACK information required by a transmission format of the HARQ-ACK information, which may support carrier aggregation with more CCs in TDD UL/DL configuration 5, thereby the peak throughput of user downlink is improved.

It should be noted that: in some cases the word “bundled” is also described as “compressed” or “information compression”, and the like.

On the other hand, although not illustrated, it will be understood by those of ordinary skill in the art that each of the UE, and the base station may includes a receiver, a controller, and a transmitter. It will be assumed that the receiver, the controller, and the transmitter included in each of the UE and the base station may be implemented as separate units, however it is possible that the receiver, the controller, and the transmitter included in each of the UE and the base station may be incorporated into a single unit.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for transmitting hybrid automatic repeat request-acknowledgement (HARQ-ACK) information, which is used when each component carrier (CC) of carrier aggregation uses time division duplex uplink/downlink configuration (TDD UL/DL configuration) 5, the method comprising:
receiving, by a user equipment (UE), physical downlink shared channel (PDSCH) data from each CC, and obtaining corresponding HARQ-ACK information;
obtaining, by the UE, size of a bundling window within a current HARQ-ACK feedback cycle;
bundling, by the UE, the HARQ-ACK information within the current bundling window according to the number of configured CCs, the size of the bundling window, and a transmission format of the HARQ-ACK information, so that a total number of bits of the bundled HARQ-ACK information of all CCs is compliant with a requirement associated with a length of the HARQ-ACK information required by the transmission format of the HARQ-ACK information; and
transmitting, by the UE, the bundled HARQ-ACK information to a base station via an uplink physical channel.

2. The method according to claim 1, wherein the requirement associated with the length of the HARQ-ACK information required by the transmission format of the HARQ-ACK information comprises the length being less than or equal to Nb bits, wherein the UE bundling the HARQ-ACK information within the current bundling window comprises when a total number of bits of the HARQ-ACK information of all the CCs is greater than Nb, then the UE performs spatial bundling on the HARQ-ACK information of all the CCs, and when the total number of bits of the HARQ-ACK information of all the CCs after being bundled by the spatial bundling is greater than Nb, then the UE performs time domain bundling on the HARQ-ACK information of all the CCs.

3. The method according to claim 2, wherein the requirement associated with the length of the HARQ-ACK information required by the transmission format of the HARQ-ACK information comprises the length being less than or equal to Nb bits,
wherein the UE bundling the HARQ-ACK information within the current bundling window comprises when a total number of bits of the HARQ-ACK information of all the CCs is greater than Nb, then the UE performs spatial bundling on the HARQ-ACK information of each CC one by one from one of the CCs, until the total number of bits of the HARQ-ACK information of all the CCs is less than or equal to Nb or the spatial bundling is performed on the HARQ-ACK information of all CCs, and when the total number of bits of the HARQ-ACK information of all the CCs after being bundled by the spatial bundling is greater than Nb, then the UE performs time domain bundling on the HARQ-ACK information of each CC one by one from one of the CCs, until the total number of bits of the HARQ-ACK information of all the CCs is less than or equal to Nb.

4. The method according to claim 3, wherein performing the time domain bundling comprises:
reordering the HARQ-ACK information of each downlink sub-frame within the bundling window of the CC according to an ascending order of downlink assignment indicators (DAI) of the downlink sub-frames within the bundling window of the CC, setting the HARQ-ACK information of a downlink sub-frame in which a physical downlink control channel (PDCCH) is not received as DTX and ordered in the back, and obtaining reordered HARQ-ACK information; checking the reordered HARQ-ACK information according to Table 1, so that a corresponding HARQ-ACK indicator is obtained; the HARQ-ACK indicator being the HARQ-ACK information of the CC after being bundled by the time domain bundling:
TABLE 1

| Serial | | | | | | | | | | HARQ-ACK |
|---|---|---|---|---|---|---|---|---|---|---|
| number | HARQ-ACK information | | | | | | | | | indicator |
| 0 | ACK | ACK | ACK | ACK | ACK | ACK | ACK | ACK | ACK | 0000 |
| 1 | ACK | ACK | ACK | ACK | ACK | ACK | ACK | ACK | N/D | 0001 |
| 2 | ACK | ACK | ACK | ACK | ACK | ACK | ACK | N/D | any | 0010 |
| 3 | ACK | ACK | ACK | ACK | ACK | ACK | N/D | any | any | 0011 |
| 4 | ACK | ACK | ACK | ACK | ACK | N/D | any | any | any | 0100 |
| 5 | ACK | ACK | ACK | ACK | N/D | any | any | any | any | 0101 |
| 6 | ACK | ACK | ACK | N/D | any | any | any | any | any | 0110 |
| 7 | ACK | ACK | N/D | any | any | any | any | any | any | 0111 |
| 8 | ACK | N/D | any | any | any | any | any | any | any | 1000 |
| 9 | N/D | any | any | any | any | any | any | any | any | 1001 |

5. The method according to claim 3, wherein performing the time domain bundling comprises:
determining the number of downlink sub-frames actually scheduled by the base station within the current bundling window according to uplink downlink assignment indicator (UL DAL) in uplink grant (UL grant) of a PDCCH scheduling a physical uplink shared channel (PUSCH) and the number of downlink sub-frames, received by the UE, of the PDCCH;
reordering the HARQ-ACK information of downlink sub-frames scheduled actually within the bundling window of the CC according to an ascending order of DAIs of downlink sub-frames within the bundling window of the CC, the HARQ-ACK information of a downlink sub-frame in which a PDCCH is not received is set as DTX and ordered in the back, and reordered HARQ-ACK information whose length is the number of the downlink sub-frames scheduled is obtained; and
when the length of the reordered HARQ-ACK information is greater than 7, then reordering HARQ-ACK information according to Table 2, so that a corresponding HARQ-ACK indicator is obtained, when the length of the reordered HARQ-ACK information is less than or equal to 7, then reordering HARQ-ACK information according to Table 3, so that the corresponding HARQ-ACK indicator is obtained; the HARQ-ACK indicator is the HARQ-ACK information of the CC after being bundled by the time domain bundling:
TABLE 2

| Serial | | | | | | | | | | HARQ-ACK |
|---|---|---|---|---|---|---|---|---|---|---|
| number | HARQ-ACK information | | | | | | | | | indicator |
| 0 | ACK | ACK | ACK | ACK | ACK | ACK | ACK | ACK | ACK | 0000 |
| 1 | ACK | ACK | ACK | ACK | ACK | ACK | ACK | ACK | N/D | 0001 |
| 2 | ACK | ACK | ACK | ACK | ACK | ACK | ACK | N/D | any | 0010 |
| 3 | ACK | ACK | ACK | ACK | ACK | ACK | N/D | any | any | 0011 |
| 4 | ACK | ACK | ACK | ACK | ACK | N/D | any | any | any | 0100 |
| 5 | ACK | ACK | ACK | ACK | N/D | any | any | any | any | 0101 |
| 6 | ACK | ACK | ACK | N/D | any | any | any | any | any | 0110 |
| 7 | ACK | ACK | N/D | any | any | any | any | any | any | 0111 |
| 8 | ACK | N/D | any | any | any | any | any | any | any | 1000 |
| 9 | N/D | any | any | any | any | any | any | any | any | 1001 |

TABLE 3

| Serial | | | | | | | | HARQ-ACK |
|---|---|---|---|---|---|---|---|---|
| number | HARQ-ACK information | | | | | | | indicator |
| 0 | ACK | ACK | ACK | ACK | ACK | ACK | ACK | 000 |
| 1 | ACK | ACK | ACK | ACK | ACK | ACK | N/D | 001 |
| 2 | ACK | ACK | ACK | ACK | ACK | N/D | any | 010 |
| 3 | ACK | ACK | ACK | ACK | N/D | any | any | 011 |
| 4 | ACK | ACK | ACK | N/D | any | any | any | 100 |
| 5 | ACK | ACK | N/D | any | any | any | any | 101 |
| 6 | ACK | N/D | any | any | any | any | any | 110 |
| 7 | N/D | any | any | any | any | any | any | 111 |

6. The method according to claim 3, wherein the performing the time domain bundling comprises:
reordering the HARQ-ACK information of each downlink sub-frame within the bundling window of the CC according to an ascending order of DAIs of downlink sub-frames within the bundling window of the CC, setting the HARQ-ACK information of a downlink sub-frame in which a PDCCH is not received as DTX and ordered in the back, and obtaining reordered HARQ-ACK information;
when the number of consecutive ACKs from the first bit in the reordered HARQ-ACK information is 3, 6 or 9, and values of remaining bits are all DTX, then mapping the reordered HARQ-ACK information as A, A, and setting a corresponding HARQ-ACK indicator to 11;
when the number of the consecutive ACKs from the first bit in the reordered HARQ-ACK information is 2 or 5, and the values of the remaining bits are all DTX, or, the number of the consecutive ACKs from the first bit is 8 and the value of the ninth bit is NACK/DTX, then mapping the reordered HARQ-ACK information as N/D, A, and setting the corresponding HARQ-ACK indicator to 10;
when the number of the consecutive ACKs from the first bit in the reordered HARQ-ACK information is 1 or 4, and the values of the remaining bits are all DTX, or, the number of the consecutive ACKs from the first bit is 7, the value of the eighth bit is NACK/DTX, and the value of the ninth bit is any of ACK, NACK and DTX, then mapping the reordered HARQ-ACK information is mapped as A, N/D, and setting the corresponding HARQ-ACK indicator to 01;
when the value of the first bit in the reordered HARQ-ACK information is DTX, and the values of the remaining eight bits are any of ACK, NACK and DTX, then not transmitting the HARQ-ACK information; and
otherwise, mapping the reordered HARQ-ACK information as N/D, N/D, and setting the corresponding HARQ-ACK indicator to 00,
wherein the HARQ-ACK indicator includes the HARQ-ACK information of the CC after being bundled by the time domain bundling.

7. The method according to claim 1, further comprising:
obtaining the size of the bundling window in the current HARQ-ACK feedback cycle by reading system configuration information; and
transmitting, by the UE, the bundled HARQ-ACK information of all the CC to the base station via a PUCCH.

8. The method according to claim 1, further comprising:
obtaining the size of the bundling window in the current HARQ-ACK feedback cycle by reading a UL DAL in UL grant of a PDCCH of a PUSCH, and according to the number of downlink sub-frames in which the PDCCH is received by the UE; and
transmitting, by the UE, the bundled HARQ-ACK information of all the CC to the base station via a PUSCH.

9. The method according to claim 1, wherein the transmission format of the HARQ-ACK information includes PUCCH format 3 or PUCCH format 1b.

10. An apparatus in a user equipment (UE) configured to transmit HARQ-ACK information, which is used for each component carrier (CC) of carrier aggregation uses time division duplex uplink/downlink configuration (TDD UL/DL configuration) 5, the apparatus comprising:
a receiver configured to receive physical downlink shared channel (PDSCH) data from each CC;
a controller configured to obtain corresponding HARQ-ACK information and size of a bundling window within a current HARQ-ACK feedback cycle, and bundle the HARQ-ACK information within the current bundling window according to the number of configured CCs, the size of the bundling window, and a transmission format of the HARQ-ACK information, so that a total number of bits of the bundled HARQ-ACK information of all CCs is compliant with a requirement associated with a length of the HARQ-ACK information required by the transmission format of the HARQ-ACK information; and
a transmitter configured to transmit the bundled HARQ-ACK information to a base station via a uplink physical channel.

11. The apparatus according to claim 10, wherein the requirement associated with the length of the HARQ-ACK information required by the transmission format of the HARQ-ACK information comprises the length is less than or equal to Nb bits, and
when a total number of bits of the HARQ-ACK information of all the CCs is greater than Nb, then the controller is configured to perform spatial bundling on the HARQ-ACK information of all the CCs; and
when the total number of bits of the HARQ-ACK information of all the CCs after being bundled by the spatial bundling is greater than Nb, then the controller is configured to perform time domain bundling on the HARQ-ACK information of all the CCs.

12. The apparatus according to claim 11, wherein the requirement associated with the length of the HARQ-ACK information required by the transmission format of the HARQ-ACK information comprises the length is less than or equal to Nb bits;
when a total number of bits of the HARQ-ACK information of all the CCs is greater than Nb, then the controller is configured to perform spatial bundling on the HARQ-ACK information of each CC one by one from one of the CCs, until the total number of bits of the HARQ-ACK information of all the CCs is less than or equal to Nb or the spatial bundling is performed on the HARQ-ACK information of all CCs; and
when the total number of bits of the HARQ-ACK information of all the CCs after being bundled by the spatial bundling is greater than Nb, then the controller is configured to perform time domain bundling on the HARQ-ACK information of each CC one by one from one of the CCs, until the total number of bits of the HARQ-ACK information of all the CCs is less than or equal to Nb.

13. The apparatus according to claim 12, wherein the controller is configured to, when the HARQ-ACK information of each downlink sub-frame within the bundling window of the CC is reordered according to an ascending order of downlink assignment indicators (DAI) of the downlink sub-frames within the bundling window of the CC, set the HARQ-ACK information of a downlink sub-frame in which a physical downlink control channel (PDCCH) is not received as DTX and ordered in the back, and obtain reordered HARQ-ACK information; checking the reordered HARQ-ACK information according to Table 4, so that a corresponding HARQ-ACK indicator is obtained; the HARQ-ACK indicator including the HARQ-ACK information of the CC after being bundled by the time domain bundling:
TABLE 4

| Serial | | | | | | | | | | HARQ-ACK |
|---|---|---|---|---|---|---|---|---|---|---|
| number | HARQ-ACK information | | | | | | | | | indicator |
| 0 | ACK | ACK | ACK | ACK | ACK | ACK | ACK | ACK | ACK | 0000 |
| 1 | ACK | ACK | ACK | ACK | ACK | ACK | ACK | ACK | N/D | 0001 |
| 2 | ACK | ACK | ACK | ACK | ACK | ACK | ACK | N/D | any | 0010 |
| 3 | ACK | ACK | ACK | ACK | ACK | ACK | N/D | any | any | 0011 |
| 4 | ACK | ACK | ACK | ACK | ACK | N/D | any | any | any | 0100 |
| 5 | ACK | ACK | ACK | ACK | N/D | any | any | any | any | 0101 |
| 6 | ACK | ACK | ACK | N/D | any | any | any | any | any | 0110 |
| 7 | ACK | ACK | N/D | any | any | any | any | any | any | 0111 |
| 8 | ACK | N/D | any | any | any | any | any | any | any | 1000 |
| 9 | N/D | any | any | any | any | any | any | any | any | 1001 |

14. The apparatus according to claim 12, wherein when the number of downlink sub-frames actually scheduled by the base station within the current bundling window is determined according to uplink downlink assignment indicator (UL DAL) in uplink grant (UL grant) of a PDCCH scheduling a physical uplink shared channel (PUSCH) and the number of downlink sub-frames, received by the receiver, of the PDCCH:
the controller is configured to reorder the HARQ-ACK information of downlink sub-frames scheduled actually within the bundling window of the CC according to an ascending order of DAIs of downlink sub-frames within the bundling window of the CC, set the HARQ-ACK information of a downlink sub-frame in which a PDCCH is not received is set as DTX and ordered in the back, and reordered HARQ-ACK information whose length is the number of the downlink sub-frames scheduled actually is obtained;
when the length of the reordered HARQ-ACK information is greater than 7, checking the reordered HARQ-ACK information according to Table 5, so that a corresponding HARQ-ACK indicator is obtained; and
when the length of the reordered HARQ-ACK information is less than or equal to 7, checking the reordered HARQ-ACK information according to Table 6 so that the corresponding HARQ-ACK indicator is obtained; the HARQ-ACK indicator including the HARQ-ACK information of the CC after being bundled by the time domain bundling:
TABLE 5

| Serial | | | | | | | | | | HARQ-ACK |
|---|---|---|---|---|---|---|---|---|---|---|
| number | HARQ-ACK information | | | | | | | | | indicator |
| 0 | ACK | ACK | ACK | ACK | ACK | ACK | ACK | ACK | ACK | 0000 |
| 1 | ACK | ACK | ACK | ACK | ACK | ACK | ACK | ACK | N/D | 0001 |
| 2 | ACK | ACK | ACK | ACK | ACK | ACK | ACK | N/D | any | 0010 |
| 3 | ACK | ACK | ACK | ACK | ACK | ACK | N/D | any | any | 0011 |
| 4 | ACK | ACK | ACK | ACK | ACK | N/D | any | any | any | 0100 |
| 5 | ACK | ACK | ACK | ACK | N/D | any | any | any | any | 0101 |
| 6 | ACK | ACK | ACK | N/D | any | any | any | any | any | 0110 |
| 7 | ACK | ACK | N/D | any | any | any | any | any | any | 0111 |
| 8 | ACK | N/D | any | any | any | any | any | any | any | 1000 |
| 9 | N/D | any | any | any | any | any | any | any | any | 1001 |

TABLE 6

| Serial | | | | | | | | HARQ-ACK |
|---|---|---|---|---|---|---|---|---|
| number | HARQ-ACK information | | | | | | | indicator |
| 0 | ACK | ACK | ACK | ACK | ACK | ACK | ACK | 000 |
| 1 | ACK | ACK | ACK | ACK | ACK | ACK | N/D | 001 |
| 2 | ACK | ACK | ACK | ACK | ACK | N/D | any | 010 |
| 3 | ACK | ACK | ACK | ACK | N/D | any | any | 011 |
| 4 | ACK | ACK | ACK | N/D | any | any | any | 100 |
| 5 | ACK | ACK | N/D | any | any | any | any | 101 |
| 6 | ACK | N/D | any | any | any | any | any | 110 |
| 7 | N/D | any | any | any | any | any | any | 111 |

15. The apparatus according to claim 12, wherein the controller is configured to:
reorder the HARQ-ACK information of each downlink sub-frame within the bundling window of the CC according to an ascending order of DAIs of downlink sub-frames within the bundling window of the CC, set the HARQ-ACK information of a downlink sub-frame in which a PDCCH is not received as DTX and ordered in the back, and reordered HARQ-ACK information is obtained;
when the number of consecutive ACKs from the first bit in the reordered HARQ-ACK information is 3, 6 or 9, and values of remaining bits are all DTX, map the reordered HARQ-ACK information as A, A, and a corresponding HARQ-ACK indicator is 11;
when the number of the consecutive ACKs from the first bit in the reordered HARQ-ACK information is 2 or 5, and the values of the remaining bits are all DTX, or, the number of the consecutive ACKs from the first bit is 8 and the value of the ninth bit is NACK/DTX, map the reordered HARQ-ACK information as N/D, A, and the corresponding HARQ-ACK indicator is 10;
when the number of the consecutive ACKs from the first bit in the reordered HARQ-ACK information is 1 or 4, and the values of the remaining bits are all DTX, or, the number of the consecutive ACKs from the first bit is 7, the value of the eighth bit is NACK/DTX, and the value of the ninth bit is any of ACK, NACK and DTX, map the reordered HARQ-ACK information as A, N/D, and the corresponding HARQ-ACK indicator is 01;
when the value of the first bit in the reordered HARQ-ACK information is DTX, and the values of the remaining eight bits are any of ACK, NACK and DTX, not transmitting the HARQ-ACK information; and
otherwise, map the reordered HARQ-ACK information as N/D, N/D, and set the corresponding HARQ-ACK indicator to 00,
wherein the HARQ-ACK indicator includes the HARQ-ACK information of the CC after being bundled by the time domain bundling.

16. The apparatus according to claim 10, wherein the controller is configured to:
obtain the size of the bundling window in the current HARQ-ACK feedback cycle by reading system configuration information, and the transmitter is configured to transmit the bundled HARQ-ACK information of all the CC to the base station via a PUCCH.

17. The apparatus according to claim 10, wherein the controller is configured to:
obtain the size of the bundling window in the current HARQ-ACK feedback cycle by reading a UL DAL in UL grant of a PDCCH of a PUSCH, and according to the number of downlink sub-frames in which the PDCCH is received by the receiver, and the transmitter is configured to transmit the bundled HARQ-ACK information of all the CC to the base station via a PUSCH.

18. The apparatus according to claim 10, wherein the transmission format of the HARQ-ACK information includes PUCCH format 3 or PUCCH format 1b.

19. Code embodied on a non-transitory, computer readable medium, when executed on a processor, configured to perform at least the following:
receive physical downlink shared channel (PDSCH) data from each CC, and obtaining corresponding HARQ-ACK information;
obtain size of a bundling window within a current HARQ-ACK feedback cycle;
bundle the HARQ-ACK information within the current bundling window according to the number of configured CCs, the size of the bundling window, and a transmission format of the HARQ-ACK information, so that a total number of bits of the bundled HARQ-ACK information of all CCs is compliant with a requirement associated with a length of the HARQ-ACK information required by the transmission format of the HARQ-ACK information; and
transmit the bundled HARQ-ACK information to a base station via an uplink physical channel.

20. The code according to claim 19, further configured to:
obtain the size of the bundling window in the current HARQ-ACK feedback cycle by reading a UL DAL in UL grant of a PDCCH of a PUSCH, and according to the number of downlink sub-frames in which the PDCCH is received by the UE; and
transmit the bundled HARQ-ACK information of all the CC to the base station via a PUSCH.
